(19) United States
(12) Patent Application Publication
(10) Pub. No.: US 2025/0241826 A1
(43) Pub. Date: Jul. 31, 2025

(54) TABLET DISPENSING DEVICE

(71) Applicant: YUYAMA MFG. CO., LTD., Osaka (JP)

(72) Inventors: Naoki KOIKE, Toyonaka-shi (JP); Akira MAEDA, Toyonaka-shi (JP)

(73) Assignee: YUYAMA MFG. CO., LTD., Osaka (JP)

(21) Appl. No.: 19/183,920

(22) Filed: Apr. 21, 2025

Related U.S. Application Data
(63) Continuation of application No. PCT/JP2023/038604, filed on Oct. 25, 2023.

(30) Foreign Application Priority Data
Oct. 26, 2022 (JP) 2022-171210

(51) Int. Cl. A61J 7/00

(52) U.S. Cl. CPC A61J 7/0076

(57) ABSTRACT

A tablet dispensing device according to one or more embodiments may include a tablet housing that houses a tablet and discharges the tablet through a tablet outlet, a rotor that is arranged inside the tablet housing and comprises a tablet guide that guides the tablet to the tablet outlet, and a tablet introduction member that guides the tablet held at the tablet housing to the tablet guide.

### CROSS REFERENCE TO RELATED APPLICATIONS

This application is a continuation application of International Application No. PCT/JP2023/038604, filed on Oct. 25, 2023, which claims priority based on the Article 8 of Patent Cooperation Treaty from prior Japanese Patent Application No. 2022-171210 filed with the Japan Patent Office on Oct. 26, 2022, the entire contents of which are incorporated herein by reference.

### TECHNICAL FIELD

The disclosure relates to a tablet dispensing device.

### BACKGROUND

A tablet dispensing device that houses a large number of tablets, rotates a rotor to guide the tablet to a tablet guide passage of the rotor, and dispenses the tablet below a partition from a tablet outlet is known. In this tablet dispensing device, when the number of tablets is small, there is a problem in that the tablet placed on the rotor is rotated together with the rotor without entering into the tablet guide passage and is retained on the rotor without being dispensed.

Japanese patent application laid-open publications JP-A-2021-137418 (“PTL 1”) and JP-A-2020-99585 (“PTL 2”) describe a tablet cassette in which an endless belt is provided above a partition action portion (partition) and a tablet retained in a rotor is brought into contact with the endless belt and dropped into a compartment room (tablet guide passage).

However, since the endless belts of PTL 1 and PTL 2 are made of a round cord-shaped rubber and interfere with the tablet in a state of being linearly stretched by supporting both ends, the tablet retained in the rotor is pushed up toward a center of the rotor by the endless belt when the tablet approaches the endless belt, and the tablet may not be guided to the tablet guide passage. In addition, since the endless belt is always in a tablet container, in a case where there are many tablets, the endless belt is an obstacle that hinders the movement of the tablet moving together with the rotor.

In the tablet dispensing device as in PTL 1 and PTL 2, particularly in a case where the tablet is a half-tablet, at a portion at which a groove of the tablet guide passage and a circumferential groove into which the partition enters intersect with each other, the half-tablet may not be discharged since a corner of the half-tablet is caught by the circumferential groove.

In the tablet dispensing device such as PTL 1 and PTL 2, since accuracy in dividing one tablet into two half-tablets is poor and sizes of the two divided half-tablets are different, a small tablet in the tablet guide passage rotates in the tablet guide passage, is sandwiched and bridged between a bottom surface of the tablet guide passage and an inner surface of a tablet housing portion, which may hinder the rotation of the rotor.

Japanese patent application laid-open publication JP-A-2022-34821 (“PTL 3”) describes a tablet dispensing device in which a compartment room (tablet guide passage) of an alignment plate (rotor) is formed of a through-hole having a circular cross section. As in PTL 3, when the tablet guide passage is the through-hole having the circular cross section, a tablet in the tablet guide passage does not interfere with an inner surface of a tablet housing portion, but the through-hole is separated from an inner wall of the tablet housing portion, and thus there is a problem that the tablet is difficult to enter the tablet guide passage.

### SUMMARY

A tablet dispensing device according to one or more embodiments may have capable of reliably guiding a tablet held at a tablet housing to a tablet guide passage and dispensing the tablet.

A tablet dispensing device according to one or more embodiments may include: a tablet housing that houses a tablet and is provided with a tablet outlet through which the tablet is discharged; a rotor that is disposed inside the tablet housing and is provided with a tablet guide which guides the tablet to the tablet outlet; and a tablet introduction member that guides the tablet held at the tablet housing to the tablet guide. In one or more embodiments, the tablet held at the tablet housing may be moved together with the rotor, may come into contact with a tablet introduction portion, may engage and may draw the tablet into the guide portion.

According to one or more embodiments, the tablet introduction member may be a rod-shaped body which projects from a tablet housing side toward the rotor. In one or more embodiments, when the tablet retained on the rotor comes into contact with the tablet introduction portion, the tablet introduction portion may be appropriately bent, the impact may be relaxed, and the tablet may be prevented from being scratched or damaged.

According one or more embodiments, the rod-shaped body may be formed in an S-shape as viewed from a side surface. In one or more embodiments, a stroke from a base to a tip portion of the rod-shaped body may be increased, and a reaction force received from the tablet to the tip may be reduced. In addition, by a forward and backward rotation operation of the rotor, the same deformation may be received and the same action of introducing the tablet into the tablet guide may be performed even when the reaction force is applied from either the left or right side as viewed from above.

According to one or more embodiments, a tip of the tablet introduction member may be separated from the tablet housing by a distance less than a diameter of the tablet from an inner surface of the tablet housing, in a plan view of the rotor. In one or more embodiments, the tablet in contact with the inner surface of the tablet housing may be reliably brought into contact with the tablet introduction member and guided to the tablet guide.

According to one or more embodiments, the tip of the tablet introduction member may be located radially outward of the center of the tablet guide, in the plan view of the rotor. In one or more embodiments, the tablet in contact with the inner surface of the tablet housing may be reliably brought into contact with the tip of the tablet introduction member and guided to the tablet guide.

According one or more embodiments, the tablet introduction member may include a plurality of rod-shaped bodies. In one or more embodiments, since a tablet accumulated on the rotor may have a plurality of opportunities to come into contact with the tablet introduction member, even the tablet that does not come into contact with the tablet introduction member for the first time and does not enter the tablet guide may be subsequently brought into contact with the tablet introduction member and may be guided to the tablet guide.

According one or more embodiments, an interval between the plurality of rod-shaped bodies may be equal to or more than a diameter of the tablet. In one or more embodiments, since the tablet may not be placed on the plurality of rod-shaped bodies, the tablet may be reliably brought into contact with the rod-shaped body and guided into the tablet guide.

According to one or more embodiments, tips of the plurality of rod-shaped bodies may have different heights with respect to the rotor. In one or more embodiments, even a tablet caught at an inlet of the tablet guide may be dropped into the tablet guide by the rod-shaped body having a low height of the tip.

According to one or more embodiments, one of the plurality of rod-shaped bodies may enter an outer peripheral recess portion formed at a side surface of the rotor in a circumferential direction. In one or more embodiments, even a tablet caught inside the tablet guide may be guided downward to the tablet guide by the rod-shaped body of which the tip enters the outer peripheral recess portion.

According to one or more embodiments, the tablet introduction member may be provided to be movable forward and backward from a tablet housing side. In one or more embodiments, since the tablet may be likely to enter the tablet guide in a case where the stock amount of tablets in the tablet housing exceeds a predetermined amount, the tablet introduction member may be retracted. When the stock amount of tablets in the tablet housing is equal to or less than the predetermined amount, the tablet introduction member may be advanced such that the tablet is reliably brought into contact with the tablet introduction member and guided into the tablet guide and the tablet may be prevented from being accumulated on the rotor.

According to one or more embodiments, there is provided a tablet dispensing device that may include: a tablet housing that houses a tablet and is provided with a tablet outlet through which the tablet is discharged; a rotor that is disposed inside the tablet housing and is provided with a tablet guide which guides the tablet to the tablet outlet; a partition that partitions the tablet guide such that one tablet in the tablet guide is located at a lower side of the tablet guide; and a tablet introduction member that changes a posture of the tablet of the tablet guide above the partition. In one or more embodiments, the tablet that may be clogged and held at the tablet guide above the partition may be dropped below the tablet guide by changing the posture by the tablet introduction member, and thus the retaining of the tablet at the tablet guide may be prevented.

According to one or more embodiments, a tip of the tablet introduction member may enter an outer peripheral recess portion formed at a side surface of the rotor in a circumferential direction. In one or more embodiments, since the tip of the tablet introduction member which enters the outer peripheral recess portion may be likely to come into contact with the tablet, which is clogged and held at the tablet guide, the posture of the tablet may be reliably changed and the tablet can be guided downward into the tablet guide.

According to one or more embodiments, there is provided a tablet dispensing device that may include: a tablet housing that houses a tablet and is provided with a tablet outlet through which the tablet is discharged; a rotor that is disposed inside the tablet housing and is provided with a tablet guide which guides the tablet to the tablet outlet; and a partition that partitions the tablet guide such that one tablet in the tablet guide is discharged to the tablet outlet through the tablet guide, in which a circumferential groove into which the partition enters is formed at an outer peripheral surface of the rotor, and a chamfer is provided at an upper end portion of the tablet guide below the circumferential groove. In one or more embodiments, in a case where the tablet is a half-tablet, a corner of the half-tablet may not be caught by the upper end portion of the tablet guide below the circumferential groove in the tablet guide passage.

According to one or more embodiments, there is provided a tablet dispensing device that may include: a tablet housing that houses a tablet and is provided with a tablet outlet through which the tablet is discharged; a rotor that is disposed inside the tablet housing and is provided with a tablet guide which guides the tablet to the tablet outlet; and a partition that partitions the tablet guide such that one tablet in the tablet guide is discharged to the tablet outlet through the tablet guide, in which a circumferential groove into which the partition enters is formed at an outer peripheral surface of the rotor, and a width of the tablet guide below the circumferential groove is more than a width of the tablet guide above the circumferential groove. In one or more embodiments, a case where the tablet may be a half-tablet, a corner of the half-tablet may not be caught by the upper end portion of the tablet guide below the circumferential groove in the tablet guide passage.

According to one or more embodiments, there is provided a tablet dispensing device that may include: a tablet housing that houses a tablet and is provided with a tablet outlet through which the tablet is discharged; and a rotor that is disposed inside the tablet housing and is provided with a tablet guide which guides the tablet to the tablet outlet, in which the tablet guide is a groove having a cross section in an elliptical shape in a direction perpendicular to a shaft of the rotor. In one or more embodiments, the tablet may not interfere with the inner surface of the tablet housing in the tablet guide passage and the rotation of the rotor may not be hindered, and thus the tablet may be reliably discharged.

According to one or more embodiments, the tablet held at the tablet housing may be reliably guided to the tablet guide passage and dispensed. According to one or more embodiments, in a case where the tablet is a half-tablet, a corner of the half-tablet may not be caught by the circumferential groove in the tablet guide passage and may be smoothly discharged. According to one or more embodiments, the tablet may not interfere with the inner surface of the tablet housing in the tablet guide passage and the rotation of the rotor may not be hindered, and thus the tablet may be reliably discharged.

### BRIEF DESCRIPTION OF DRAWINGS

FIG. 1 is a diagram illustrating a perspective view of a tablet dispensing device according to a first embodiment or embodiments as viewed obliquely from above.

FIG. 2 is a diagram illustrating a perspective view of a tablet dispensing device such as is shown in FIG. 1 as viewed obliquely from below.

FIG. 3 is a diagram illustrating a perspective view of a state in which a rotor, a partition, and a tablet introduction member of a tablet dispensing device such as is shown in FIG. 1 are detached.

FIG. 4 is a diagram illustrating an exploded perspective view of a rotor as viewed from an oblique upper side.

FIG. 5A is a diagram illustrating an exploded perspective view of a rotor as viewed obliquely from below.

FIG. 5B is a diagram illustrating a cross-sectional view of an attachment and detachment structure of a rotor.

FIG. 5C is a diagram illustrating a partially exploded perspective view of a shaft portion.

FIG. 5D is diagram illustrating a cross-sectional view of a situation when a rotor is detached.

FIG. 6 is a diagram illustrating a perspective view of a partition and a tablet introduction member.

FIGS. 7A and 7B are diagrams illustrating a plan view of an action of the rotor and a tablet introduction member.

FIG. 8 is a diagram illustrating a cross-sectional view of a tablet dispensing device.

FIG. 9A is a diagram illustrating a front view of a tablet guide passage in a related art.

FIG. 9B is a diagram illustrating a front view of an example of a tablet guide passage according to one or more embodiments.

FIG. 9C is a diagram illustrating a front view of another example of a tablet guide passage.

FIG. 10A is a diagram illustrating an enlarged plan view of an example of a tablet guide passage in a related art.

FIG. 10B is a diagram illustrating an enlarged plan view of another example of a tablet guide passage in a related art.

FIG. 10C is a diagram illustrating an enlarged plan view of a tablet guide passage according to one or more embodiments.

FIG. 10D is a diagram illustrating a cross-sectional view taken along line d-d such as is shown in FIG. 10C.

FIGS. 11A and 11B are diagrams illustrating a plan view of a modification example of a tablet introduction member.

FIG. 11C is a diagram illustrating a perspective view illustrating another modification example of a tablet introduction member.

FIG. 11D is a diagram illustrating a side view of a tablet introduction member such as is shown in FIG. 11A.

FIG. 11E is a diagram illustrating a plan view of a tablet introduction member such as is shown in FIG. 11A.

FIG. 11F is a diagram illustrating a side view of an operation of a tablet introduction member such as shown in FIG. 11A.

FIG. 12 is a diagram illustrating a cross-sectional view of a tablet dispensing device according to a second embodiment or embodiments.

FIG. 13 is a diagram illustrating a perspective view of a rotor and a partition of the tablet dispensing device such as is shown in FIG. 12 as viewed from an oblique upper side.

FIG. 14 is a diagram illustrating a partially exploded cross-sectional view of the rotor such as is shown in FIG. 12.

FIGS. 15A, 15B, and 15C are diagrams illustrating a front view of a situation in which a tablet retained on the partition is discharged.

FIGS. 16A, 16B, and 16C are diagrams illustrating front view of a situation in which a tablet retained on a stepped portion of the rotor is discharged.

### DETAILED DESCRIPTION

Hereinafter, one or more embodiments are described with reference to the accompanying drawings.

### First Embodiment

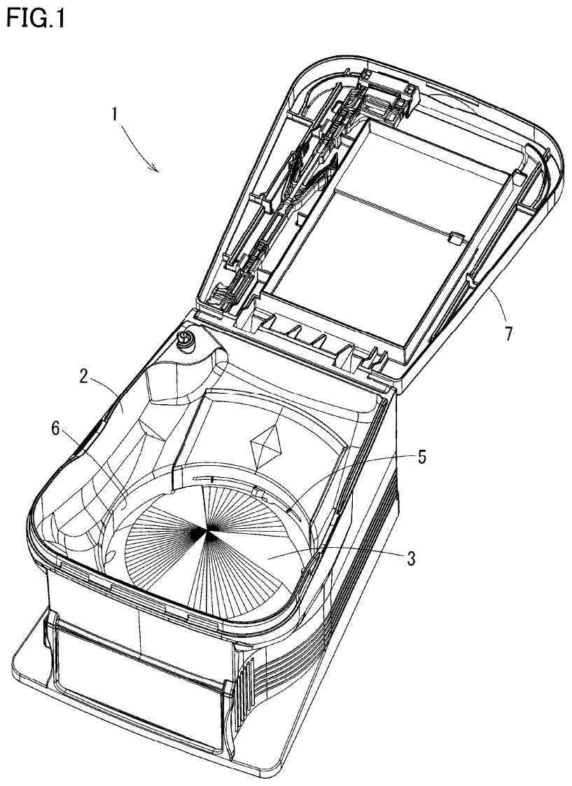

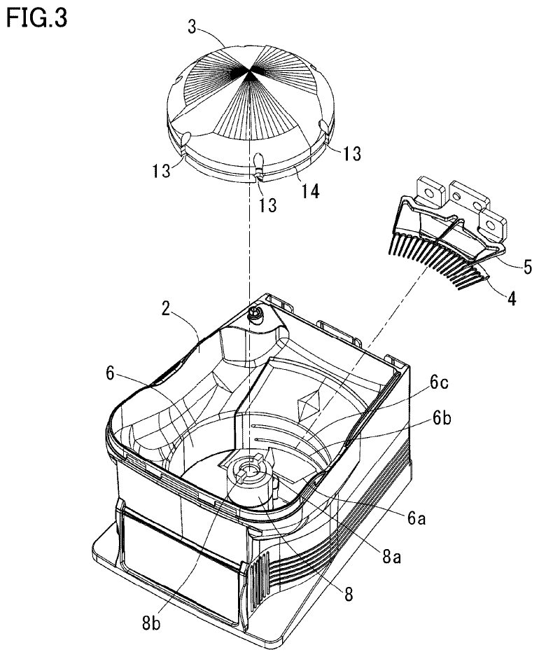

FIGS. 1 to 3 illustrate a tablet dispensing device 1 according to a first embodiment or embodiments. The tablet dispensing device 1 is attachably and detachably attached to an attachment portion (motor base) (not illustrated) and can dispense a number of tablets according to a prescription. As illustrated in FIG. 3, the tablet dispensing device 1 includes a tablet housing 2, a rotor 3, a partition 4, and a tablet introduction member 5.

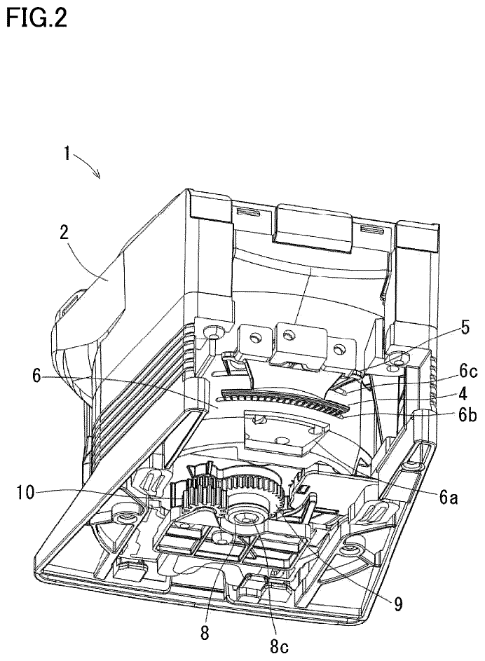

As illustrated in FIG. 1, the tablet housing 2 is a rectangular container that is open upward, and has a bottomed tubular rotor housing portion 6 below. A lid body 7 is provided on an upper end edge of the tablet housing 2 to be rotationally movable by a hinge, and the lid body 7 can open and close an upper opening of the tablet housing 2. The rotor 3 is rotatably housed in the rotor housing portion 6. As illustrated in FIG. 2, a tablet outlet 6a is formed at a bottom surface of the rotor housing portion 6 on a rear side. On a side surface of the rotor housing portion 6 on a rear side, a lower slit 6b into which the partition 4 is inserted and an upper slit 6c into which the tablet introduction member 5 is inserted are formed to extend in a circumferential direction of the rotor housing portion 6, above the tablet outlet 6a.

As illustrated in FIG. 3, a rotor drive shaft 8 that extends in an axial direction of the rotor housing portion 6 is rotatably provided at the bottom surface of the rotor housing portion 6. At an upper end of the rotor drive shaft 8, a shaft hole 8a into which a shaft portion 11c of the rotor 3 is inserted and an engaging portion 8b that engages with the rotor 3 are formed. A rotor gear 9 is attached to a lower end of the rotor drive shaft 8 as illustrated in FIG. 2. In addition, an intermediate gear 10 that meshes with the rotor gear 9 is attached to the bottom surface of the rotor housing portion 6. When the intermediate gear 10 is attached to an attachment portion (not illustrated) of the tablet housing 2, the intermediate gear 10 meshes with a motor gear of the attachment portion, and the rotor drive shaft 8 is rotated via the motor gear, the intermediate gear 10, and the rotor gear 9 when a motor in the attachment portion is driven.

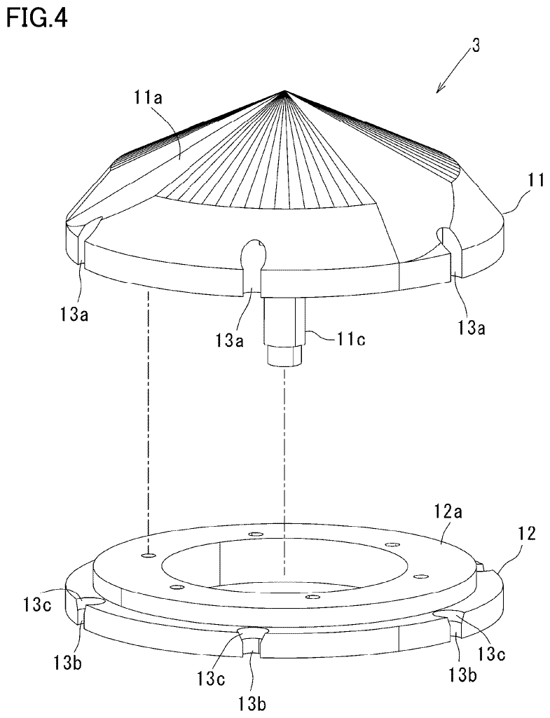

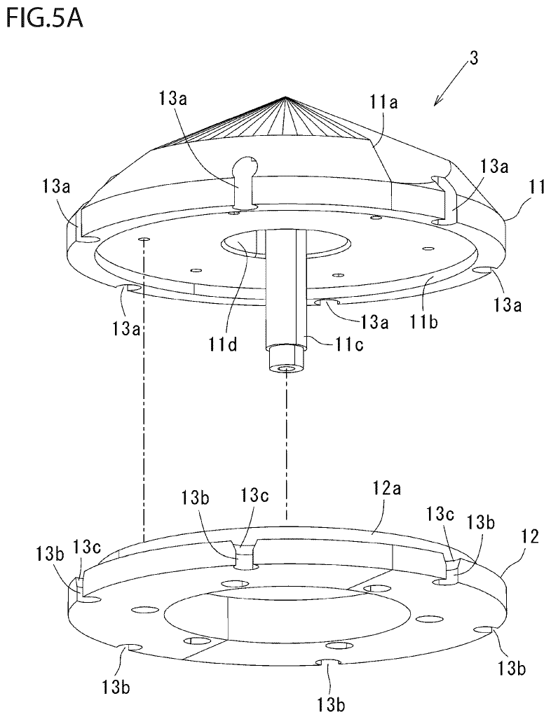

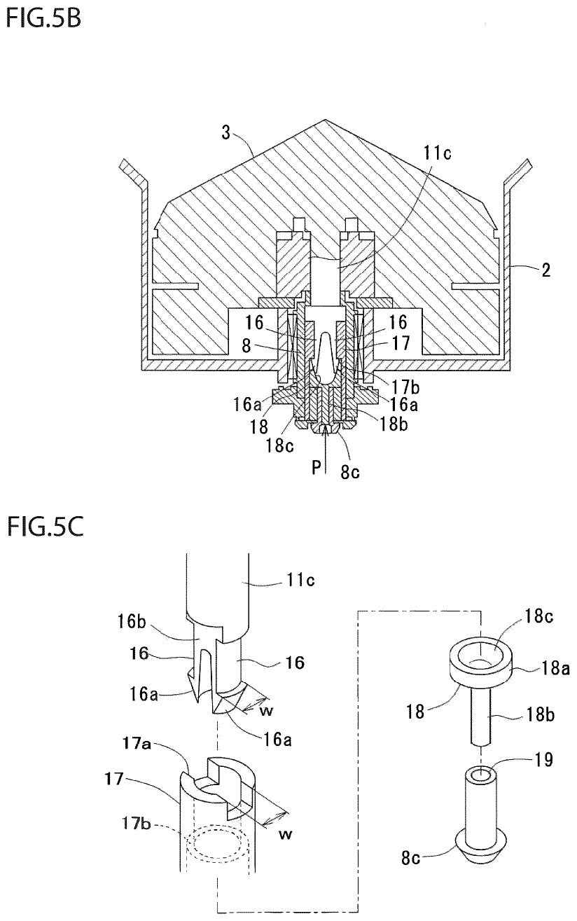

As illustrated in FIG. 3, the rotor 3 can be housed in the rotor housing portion 6 from an upper opening of the tablet housing 2. As illustrated in FIGS. 4 and 5, the rotor 3 is configured with an upper rotor member 11 and a lower rotor member 12.

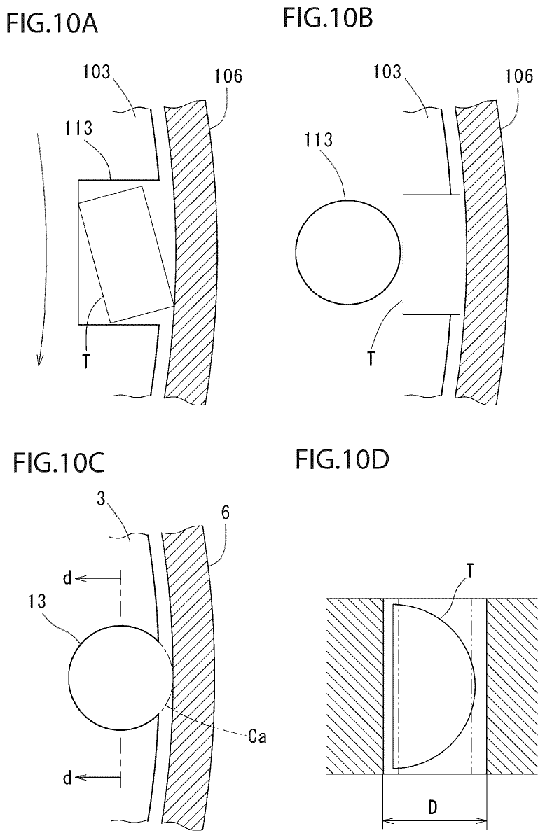

The upper rotor member 11 has a conical upper surface, and a plurality of stepped portions 11a for stirring tablets are formed at three locations in the circumferential direction. As illustrated in FIG. 5, a recess portion 11b into which a projecting portion 12a of the lower rotor member 12 is fitted is formed at a lower surface of the upper rotor member 11. In addition, the shaft portion 11c is provided to project downward at a center of the lower surface of the upper rotor member 11, and a shaft hole 11d into which the rotor drive shaft 8 is inserted is formed around the shaft portion 11c. On an outer peripheral surface of the upper rotor member 11, tablet guides 13a that extend in the axial direction are formed at positions at which the circumference is equally spaced by 6. As illustrated in FIG. 10C, the tablet guide 13a has a cross section having an elliptical shape in a direction orthogonal to the axial direction of the rotor 3, and a virtual circle Ca is in contact with an inner surface of the rotor housing portion 6. As illustrated FIG. 10D, an inner diameter of the tablet guide 13a is more than a radius of a tablet and less than a diameter of the tablet, and has a size such that a half-tablet can pass through the tablet guide 13a in a chord direction. With reference to FIG. 4, the tablet guide 13a is formed in a groove shape extending in the axial direction on the outer peripheral surface. An upper end of the tablet guide 13a is open on a conical upper surface of the upper rotor member 11, and a lower end thereof is open on a lower surface of the upper rotor member 11.

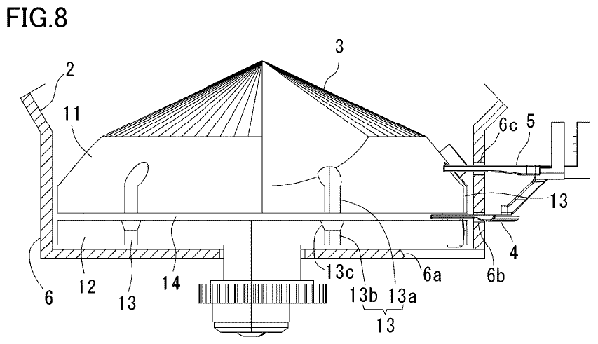

The lower rotor member 12 has an annular shape, and the projecting portion 12a that is fitted into the recess portion 11b of the upper rotor member 11 is formed at the upper surface thereof. A height of the projecting portion 12a is more than a depth of the recess portion 11b of the upper rotor member 11, and thus, when the upper rotor member 11 and the lower rotor member 12 are fitted to each other, a circumferential groove 14 is formed between the upper rotor member 11 and the lower rotor member 12 as illustrated in FIG. 8. On an outer peripheral surface of the lower rotor member 12, tablet guides 13b that extend in the axial direction are formed at positions at which the circumference is equally spaced by 6. The tablet guide 13b of the lower rotor member 12 is formed at the same position as the tablet guide 13a of the upper rotor member 11, and has the same cross-sectional shape. A chamfer 13c is provided at an upper end of the tablet guide 13b of the lower rotor member 12, that is, below the circumferential groove 14.

The upper rotor member 11 and the lower rotor member 12 are integrally assembled by screwing in a state in which the recess portion 11b of the upper rotor member 11 and the projecting portion 12a of the lower rotor member 12 are fitted to each other and the tablet guide 13a of the upper rotor member 11 and the tablet guide 13b of the lower rotor member 12 are aligned. The tablet guide 13a and the tablet guide 13b form one tablet guide 13.

Since the shaft portion 11c illustrated in FIG. 4 is inserted into the shaft hole 8a of the rotor drive shaft 8 illustrated in FIG. 3 and is fixed by a fixing screw 8c illustrated in FIG. 2 in the rotor 3, an inside of the tablet housing 2, particularly the bottom portion, cannot be cleaned. It is possible to detach the fixing screw 8c, but it is difficult for a user. FIGS. 5B and 5C illustrate a structure for attaching and detaching the rotor 3 from the inside of the tablet housing 2.

In FIGS. 5B and 5C, at a lower end of the shaft portion 11c of the rotor 3, a pair of elastic pieces 16 having claw portions 16a at tips thereof are formed. A distance between a lower portion of the shaft portion 11c and one surface of the pair of elastic pieces 16 and the other surface opposite to the one surface is a predetermined width w less than a diameter of the shaft portion 11c, and a two-surface width portion 16b is formed by the one surface and the other surface opposite to the one surface.

On the other hand, a sleeve 17 is housed inside the rotor drive shaft 8 to be integrally rotatable with the rotor drive shaft 8. The width w of an engagement groove 17a, with which the two-surface width portion 16b of the shaft portion 11c engages, is formed at an upper end of the sleeve 17. A stepped portion 17b having a reduced diameter is formed at an upper portion of the inner surface of the sleeve 17, and the claw portions 16a of the pair of elastic pieces 16 engage with the stepped portion 17b from below. An attachment and detachment pin 18 is inserted into a lower portion of an inner surface of the sleeve 17. The attachment and detachment pin 18 consists of a head portion 18a that is slidably fitted to the inner surface of the sleeve 17 and a leg portion 18b that projects downward from a lower surface of the head portion 18a. A recess portion 18c is formed at an upper surface of the head portion 18a. An inner peripheral surface of the recess portion 18c is formed of an inclined surface that is tapered downward to be in contact with the claw portions 16a of the pair of elastic pieces 16. The leg portion 18b is slidably housed in a through-hole 19 formed at a center of the fixing screw 8c.

In a state where the rotor 3 is housed in the tablet housing 2, as illustrated in FIG. 5B, the claw portions 16a of the pair of elastic pieces 16 engage with the stepped portions 17b of the sleeve 17 of the rotor drive shaft 8, and thus the rotor 3 is prevented from coming off upward. In addition, the two-surface width portion 16b of the shaft portion 11c engages with the engagement groove 17a of the sleeve 17, and the rotation of the rotor drive shaft 8 is transmitted to the shaft portion 11c of the rotor 3.

In order to detach the rotor 3 from the tablet housing 2, a pin-shaped jig is inserted through the through-hole 19 of the fixing screw 8c at a bottom of the rotor housing portion 2, and the attachment and detachment pin 18 is pushed upward as indicated by an arrow P. Therefore, an inclined surface of an inner periphery of the recess portion 18c of the attachment and detachment pin 18 presses the claw portions 16a of the pair of elastic pieces 16 of the shaft portion 11c of the rotor 3, and the pair of elastic pieces 16 are deformed in a direction approaching each other as indicated by a two-dot chain line in FIG. 5D. As a result, as illustrated in FIG. 5D, since the claw portions 16b of the pair of elastic pieces 16 are detached from the stepped portion 17b of the sleeve 17, the rotor 3 can be pulled up and taken out from the tablet housing 2.

Since this operation can also be performed by a user, the user can detach the rotor 3 at a necessary time, and can wipe off dirt or drug powder inside the tablet housing 2 or take out a piece of the tablet and clean the inside. Therefore, the tablet housing 2 can be cleaned, and contamination due to erroneous dropping of the drug pieces can be prevented.

In order to return the rotor 3 to the tablet housing 2, the shaft portion 11c of the rotor 3 is inserted into the sleeve 17 from the shaft hole 8a of the rotor drive shaft 8.

The pair of elastic pieces 16 of the shaft portion 11c enter the sleeve 17 in a state of being narrowed on the inner surface of the sleeve 17 and being deformed in a direction approaching each other, and the claw portions 16a engage with the stepped portions 17b to be attached to the upper side in an undetachable manner.

The pushing-up operation of the attachment and detachment pin 18 can be performed manually, and the protrusion provided on a dispensing table (not illustrated) may be configured to push up the attachment and detachment pin 18 when the tablet dispensing device 1 is installed at a predetermined place of the dispensing table.

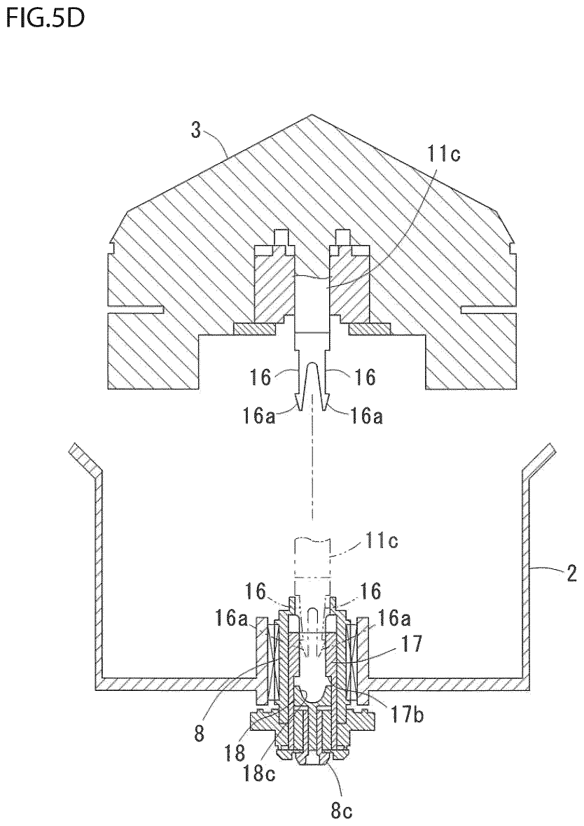

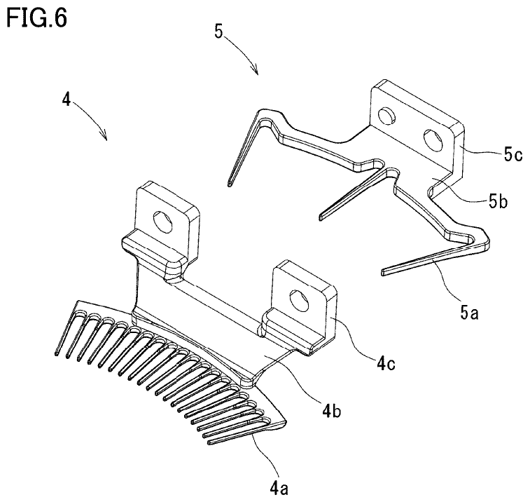

As illustrated in FIG. 6, the partition 4 includes an arc-shaped brush portion 4a, a support portion 4b that supports the brush portion 4a, and an attachment portion 4c that attaches the partition 4 to the tablet housing 2. As illustrated in FIG. 8, the brush portion 4a is inserted into the lower slit 6b of the rotor housing portion 6, enters the circumferential groove 14 of the rotor 3, and is configured to partition between the lowest tablet of the tablet guide 13 and the tablet above the lowest tablet. Since the brush portion 4a is known in the related art, detailed configuration thereof may not be described.

As illustrated in FIG. 6, the tablet introduction member 5 includes a brush portion 5a, a support portion 5b that supports the brush portion 5a, and an attachment portion 5c that attaches the tablet introduction member 5 to the tablet housing 2. The brush portion 5a consists of three rod-shaped bodies that project toward a center of the rotor 3. The rod-shaped body may be a rod-shaped body having elasticity itself or a rod-shaped body having an elastic portion such as a spring at a base. The tablet introduction member 5 is inserted into the upper slit 6c of the rotor housing portion 6 and is located above an inclined upper surface of the upper rotor member 11. In the tablet introduction member 5, a portion excluding a tip of the brush portion 5a is located outside the tablet housing 2. The number of rod-shaped bodies of the brush portion 5a is three in Examples, but the number is not limited thereto, and may be one, two, or four or more.

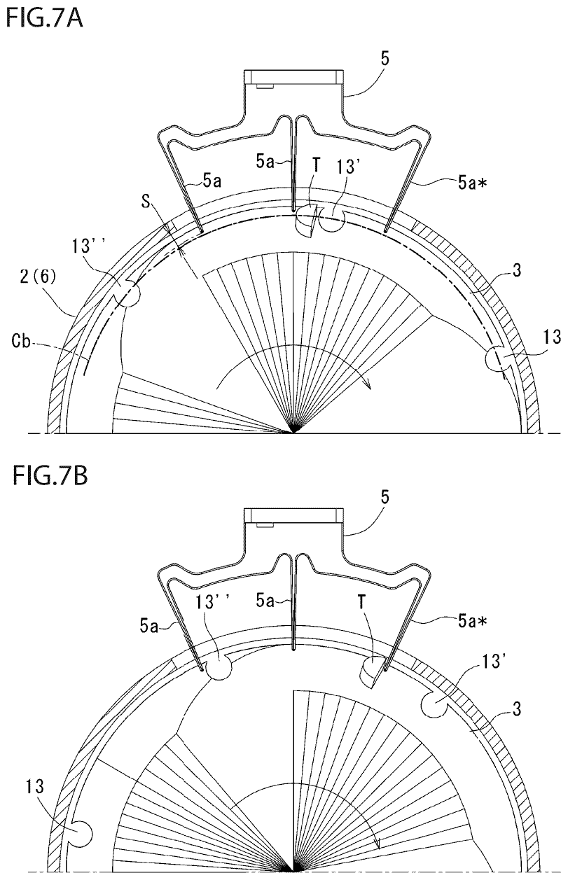

As illustrated in FIGS. 7A and 7B, it may be preferable that an interval between tips of the rod-shaped bodies of a plurality of brush portions 5a is equal to or more than a diameter of a tablet. This is because, if the interval between the tips of the rod-shaped bodies of the brush portion 5a is less than the diameter of the tablet, the tablet is placed on the brush portion 5a and is not discharged. The tip of the brush portion 5a is less than the diameter of the tablet in the plan view of the rotor 3 from an inner surface of the rotor housing portion 6 of the tablet housing 2. That is, a distance S in a radial direction between the inner surface of the rotor housing portion 6 and the tip of the brush portion 5a is less than the diameter of the tablet. In other words, the tip of the brush portion 5a is located on a radial direction outer side of the rotor 3 than a circle Cb passing through a center of the tablet guide 13 in a plan view of the rotor 3.

Next, an operation of the tablet dispensing device 1 according to one or more embodiments, particularly the tablet introduction member 5 is described.

In FIG. 8, a large number of half-tablets housed in the tablet housing 2 are stirred with rotation of the rotor 3 and enter the tablet guide 13 of the rotor 3. When the tablet guide 13 approaches the tablet outlet 6a by the rotation of the rotor 3, the tablets in the tablet guide 13 are partitioned into the lowermost tablet and the tablet above the lowermost tablet, by the partition 4. Therefore, the tablet below the partition 4 is discharged from the tablet outlet 6a and is dispensed through an attachment portion (not illustrated). Each time the tablet guide 13 passes through the tablet outlet 6a, one tablet is discharged, and the number of tablets corresponding to a prescription is packaged and dispensed.

In the related art, when the number of remaining tablets in the tablet housing 2 is small, a tablet placed on the rotor 3 is rotated together with the rotor 3, is retained on the rotor 3, and is not discharged.

In the tablet dispensing device 1 according to one or more embodiments, since the tablet introduction member 5 is provided, the tablet retained on the rotor 3 is reliably guided to the tablet guide 13 by the tablet introduction member 5.

Further, specifically, as illustrated in FIG. 7A, a tablet T that does not enter a tablet guide 13′ and is retained on the rotor 3 is moved to a rotor rotation direction downstream side together with the rotor 3, comes into contact with a brush portion 5a* of the tablet introduction member 5, and is introduced into a subsequent tablet guide 13″ by being pushed to a rotor rotation direction upstream side or bounced back and scraped by the brush portion 5a as illustrated in FIG. 7B. In this manner, the tablet T retained on the rotor 3 is reliably introduced into the tablet guide 13 and dispensed by the tablet introduction member 5.

Since the brush portion 5a of the tablet introduction member 5 consists of a rod-shaped body, when a tablet comes into contact with the brush portion 5a, the brush portion 5a is appropriately bent, the impact is relaxed, and the tablet is prevented from being scratched or damaged.

Since the tip of the brush portion 5a of the tablet introduction member 5 is less than a diameter of the tablet in a plan view of the rotor 3 from the inner surface of the tablet housing 2, the tablet in contact with the inner surface of the tablet housing 2 is reliably brought into contact with the tablet introduction member 5 and guided to the tablet guide 13.

In addition, the tip of the brush portion 5a of the tablet introduction member 5 is located on a radial direction outer side of the rotor 3 than a center of the tablet guide 13 in a plan view of the rotor 3, and thus the tablet in contact with the inner surface of the tablet housing 2 is reliably brought into contact with the tip of the tablet introduction member 5 and guided to the tablet guide 13.

Since the tablet introduction member 5 consists of a plurality of (three in Examples) rod-shaped bodies, a tablet accumulated on the rotor 3 has a plurality of opportunities to come into contact with the tablet introduction member 5, and even the tablet that does not come into contact with the tablet introduction member 5 for the first time and does not enter the tablet guide 13 is subsequently brought into contact with the tablet introduction member 5 and is guided to the tablet guide 13. Heights of the plurality of rod-shaped bodies may be different from each other. In a rod-shaped body having a certain height, a function of guiding the tablet to the tablet guide 13 may not be generated, but in a rod-shaped body having another height, the function may be generated. Therefore, by making the heights of the plurality of rod-shaped bodies different from each other, a probability that the tablet is guided to the tablet guide 13 is increased.

Since an interval between the plurality of rod-shaped bodies of the tablet introduction member 5 is equal to or more than the diameter of the tablet, the tablet is reliably brought into contact with the brush portion 5a without being placed on the brush portion 5a of the plurality of rod-shaped bodies, and is guided to the tablet guide 13.

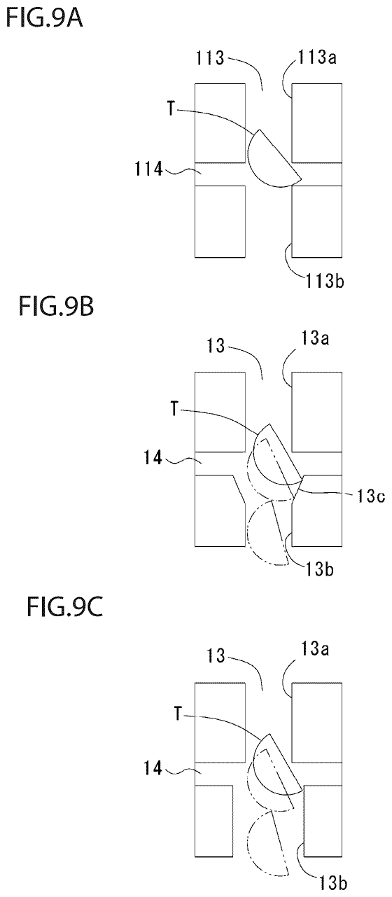

As illustrated in FIG. 9A, the tablet T, particularly a half-tablet, which enters the tablet guide 113 is caught by an upper end portion of the tablet guide 113b below the circumferential groove 114 at a corner located below the sharp both ends in the chord direction, and is not partitioned by a partition (not illustrated) located at the circumferential groove 114, and thus the discharge may be hindered.

In one or more embodiments, as illustrated in FIG. 9B, since the chamfer 13c is provided at an upper end portion of the tablet guide 13b below the circumferential groove 14, the half-tablet is dropped downward without a corner of the half-tablet being caught by the upper end portion of the tablet guide 13b below the circumferential groove 14 in the tablet guide 13, as indicated by a two-dot chain line. As illustrated in FIG. 9C, a width of the tablet guide 13b below the circumferential groove 14 may be more than a width of the tablet guide 13a above the circumferential groove 14. In this case as well, in a case where the tablet T is a half-tablet, the half-tablet is dropped downward as indicated by a two-dot chain line without a corner of the half-tablet being caught by the upper end portion of the tablet guide 13b below the circumferential groove 14.

In addition, as illustrated in FIG. 10A, in a case where the tablet guide 113 is a rectangular groove, the tablet T that enters the tablet guide 113 may interfere with a bottom of the groove of the tablet guide 113 and an inner surface of the rotor housing portion 106 at a corner of the tablet T located in a diagonal direction, and thus the rotation of the rotor 103 may be hindered. In addition, as illustrated in FIG. 10B, in a case where the tablet guide 113 is a closed circle, the tablet is placed between the tablet guide 113 and the outer peripheral surface of the rotor 103, and the tablet T may not enter the tablet guide 13 at any time.

In one or more embodiments, such as is illustrated in FIG. 10C, since a cross section of the tablet guide 13 in a direction perpendicular to a shaft of the rotor 3 is a groove having an elliptical shape, the tablet does not interfere with the inner surface of the tablet housing 2 in the tablet guide 13 and the rotation of the rotor 3 is not hindered, and the tablet can be reliably discharged.

### Modification Example 1

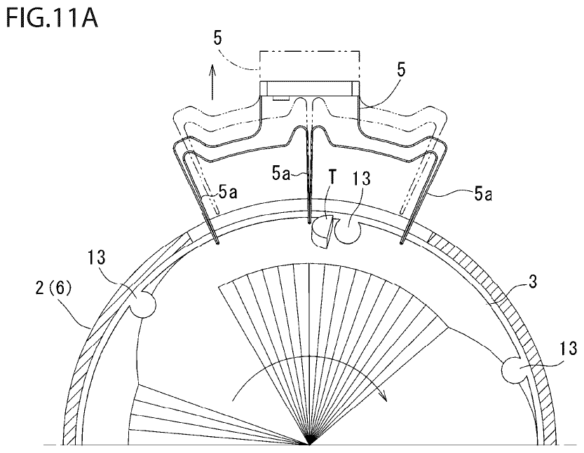

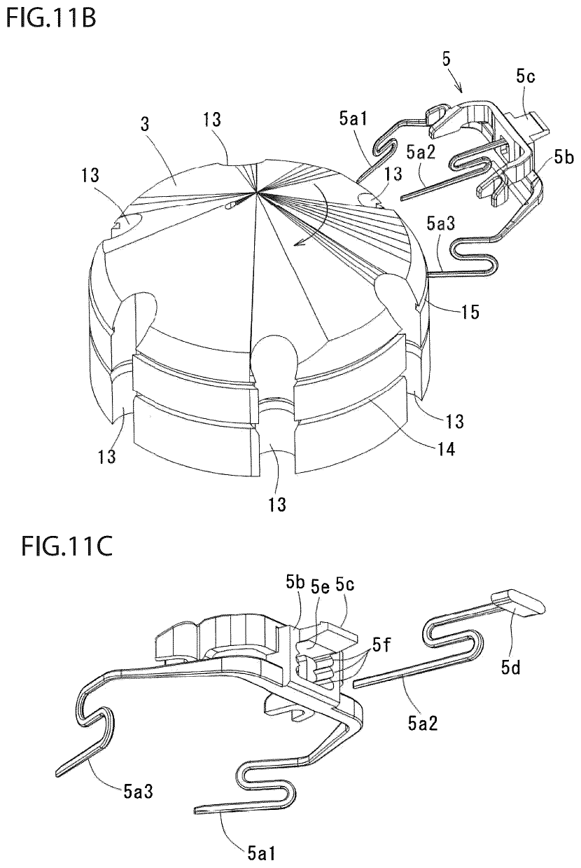

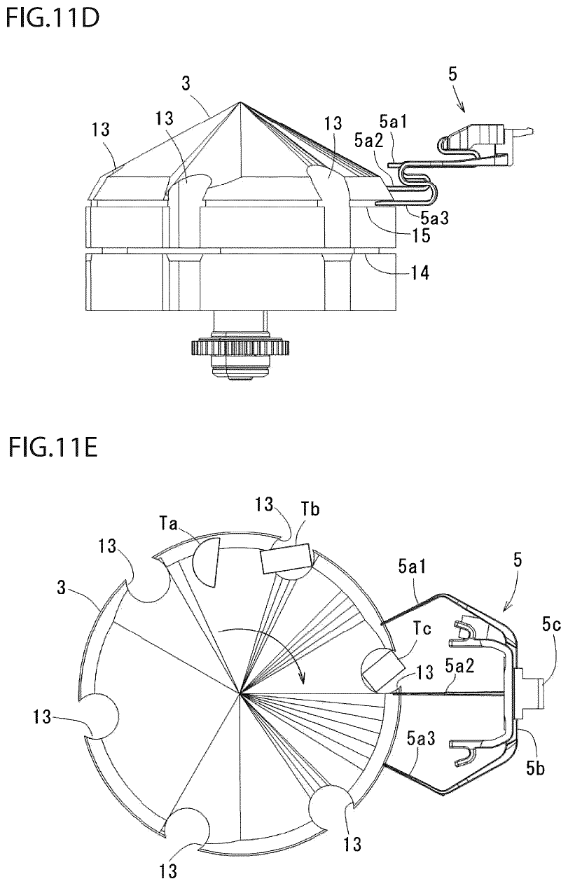

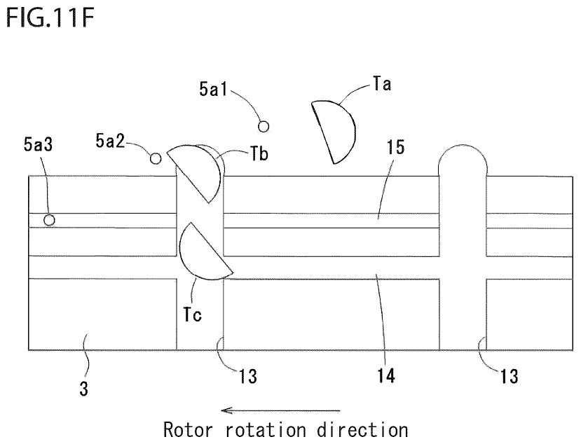

In one or more embodiments described above, the tablet introduction member 5 is fixed to the tablet housing 2, but the tablet introduction member 5 may be provided to be movable forward and backward from the tablet housing 2 side as illustrated in FIG. 11A. As a moving mechanism of the tablet introduction member 5, a motor or a solenoid that is supplied with power from the attachment portion side to which the tablet dispensing device 1 is attached can be used.

In this modification example, in a case where the stock amount of tablets in the tablet housing 2 exceeds a predetermined amount, the tablet is likely to enter the tablet guide 13. Therefore, the tablet introduction member 5 is retracted as indicated by a two-dot chain line. When the stock amount of tablets in the tablet housing 2 is equal to or less than the predetermined amount, as illustrated by the solid line, the tablet introduction member 5 is advanced such that the tablet is reliably brought into contact with the tablet introduction member 5 and guided to the tablet guide 13 and the tablet may be prevented from being accumulated on the rotor 3, as described above.

### Modification Example 2

In addition, in the tablet introduction member 5 according to one or more embodiments described above, the brush portion 5a extends linearly, but a rod-shaped body having a structure in which a base or a middle is flat or has an S-shape as viewed from the side surface, and a distance from the base to a tip is long and the rod-shaped body is easily deflected may be used.

### Modification Example 3

Further, in one or more embodiments described above, the three brush portions 5a have the same function of guiding the tablet retained on the rotor 3 to the tablet guide 13, but different functions can also be given to the three brush portions 5a.

Specifically, as illustrated in FIG. 11B, the tablet introduction member 5 has a first brush portion 5a1, a second brush portion 5a2, and a third brush portion 5a3 in order from a rotor rotation direction upstream side. The first brush portion 5a1 and the third brush portion 5a3 are provided with a base that is integrated with the support portion 5b. As illustrated in FIG. 11C, the second brush portion 5a2 has a base portion 5d that is attachable to and detachable from the support portion 5b. The base portion 5d is formed at a side edge of a rectangular hole 5e formed in the support portion 5b, and any of three upper, middle, and lower stages of engaging portions 5f is selected and engages with the base portion 5d, so that a height of a tip of the second brush portion 5a2 can be adjusted.

As illustrated in FIG. 11D, all of the first brush portion 5a1, the second brush portion 5a2, and the third brush portion 5a3 are formed in an S-shape as viewed from a side surface. Therefore, a stroke from the base to a tip portion is increased, and a reaction force received from a half-tablet to the tip can be reduced. In addition, by a forward and backward rotation operation of the rotor, as illustrated in FIG. 11E, the same deformation is received and the same action of introducing the tablet into the tablet guide is performed even when the reaction force is applied from either the left or right side as viewed from above.

In addition, as illustrated in FIG. 11D, positions of the tips of the first brush portion 5a1, the second brush portion 5a2, and the third brush portion 5a3 are different from each other.

The tips of the first brush portion 5a1 and the second brush portion 5a2 are above the rotor 3 in the same manner as the tablet introduction member 5 in FIG. 6, but the first brush portion 5a1 is located above the second brush portion 5a2.

The third brush portion 5a3 enters the outer peripheral recess portion 15 formed in the circumferential direction of the side surface of the rotor 3. The outer peripheral recess portion 15 is formed to be shallower than the tablet guide 13 and the circumferential groove 14 above the circumferential groove 14.

Therefore, as illustrated in FIG. 11F, the tablet Ta accumulated on the rotor 3 is pushed, bounced back, and engages and draws the tablet into the subsequent tablet guide 13 by the first brush portion 5a1, as described above in the first embodiment or embodiments. In addition, a tablet Tb caught at an inlet of the tablet guide 13 is not brought into contact with the first brush portion 5a1, but is bounced back by the second brush portion 5a2 and is scraped off to the tablet guide 13. Further, the tablet Tc that is caught in the circumferential groove 14 inside the tablet guide 13 is not brought into contact with the first brush portion 5a1 and the second brush portion 5a2, but is bounced back by the third brush portion 5a3 and guided downward to the tablet guide 13.

Each brush portion according to one or more embodiments described above is S-shaped to impart elasticity, but the base of the brush portion may be attached to the support portion via a spring member to maintain elasticity by the spring member.

### Second Embodiment

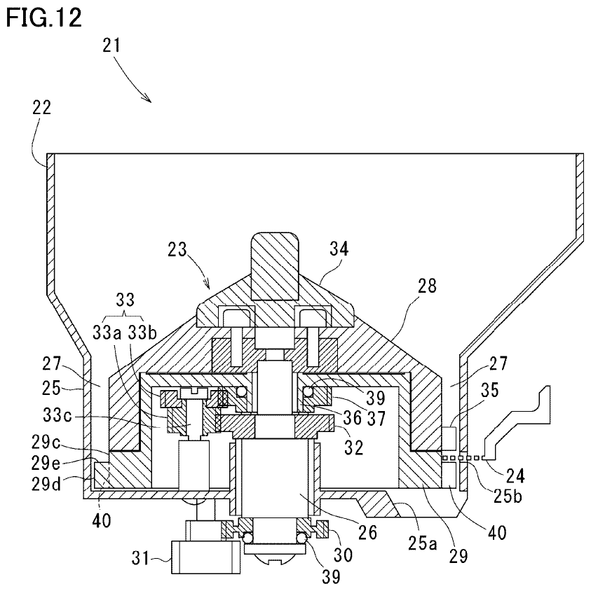

FIG. 12 illustrates a tablet dispensing device 21 according to a second embodiment or embodiments. The tablet dispensing device 21 is attachably and detachably attached to an attachment portion (motor base) (not illustrated) in the same manner as the tablet dispensing device 1 according to the first embodiment or embodiments and may dispense a number of tablets according to a prescription, and includes a tablet housing 22, a rotor 23, and a partition 24.

The tablet housing 22 is a rectangular container that is open upward, and has a bottomed tubular rotor housing portion 25 below. A lid body (not illustrated) is provided on an upper end edge of the tablet housing 22 to be rotationally movable by a hinge, and an upper opening of the tablet housing 22 can be opened and closed by the lid body. The rotor 23 is rotatably housed in the rotor housing portion 25. A tablet outlet 25a is formed at a bottom surface of the rotor housing portion 25 on a rear side. On a side surface of the rotor housing portion 25 on a rear side, a slit 25b into which the partition 24 is inserted is formed above the tablet outlet 25a to extend in the circumferential direction of the rotor housing portion 25. A rotor drive shaft 26 that extends in the axial direction of the rotor housing portion 25 is rotatably provided at a bottom surface of the rotor housing portion 25.

The rotor 23 is a so-called single-stage rotor in which the partition 24 is disposed in an annular pocket portion 27 between the rotor 23 and the rotor housing portion 25 to restrict a tablet from entering a tablet guide 40 of the rotor 23, instead of disposing the partition 4 to partition between the tablets in the tablet guide 13 upward and downward as in the first embodiment or embodiments.

The rotor 23 is configured with a first rotor 28 on an upper side and a second rotor 29 on a lower side. The first rotor 28 and the second rotor 29 are disposed coaxially around the rotor drive shaft 26 and are configured to rotate at different rotation speeds.

A first rotor gear 30 that drives the first rotor 28 is attached to a lower end of the rotor drive shaft 26. The first rotor gear 30 meshes with the first intermediate gear 31 provided on an outer surface of a bottom portion of the rotor housing portion 25. If the motor of an attachment portion is driven by the first intermediate gear 31 meshing with a motor gear of an attachment portion (not illustrated) when the tablet housing 22 is attached to the attachment portion, the first rotor 28 is rotated from the motor gear via the first intermediate gear 31 and the first rotor gear 30.

A transfer gear 32 that transmits power to the second rotor 29 side is attached to an intermediate portion of the rotor drive shaft 26. The transfer gear 32 meshes with a second intermediate gear 33 provided on the inner surface of the bottom portion of the rotor housing portion 25. The second intermediate gear 33 has an A-gear 33a that meshes with the transfer gear 32 and a B-gear 33b that meshes with the second rotor gear 37 of the second rotor 29. When the rotor drive shaft 26 is rotated, an intermediate shaft 33c of the second intermediate gear 33 is rotated via the transfer gear 32 and the A-gear 33a of the second intermediate gear 33, and the second rotor 29 is rotated via the B-gear 33b of the second intermediate gear 33 and the second rotor gear 37.

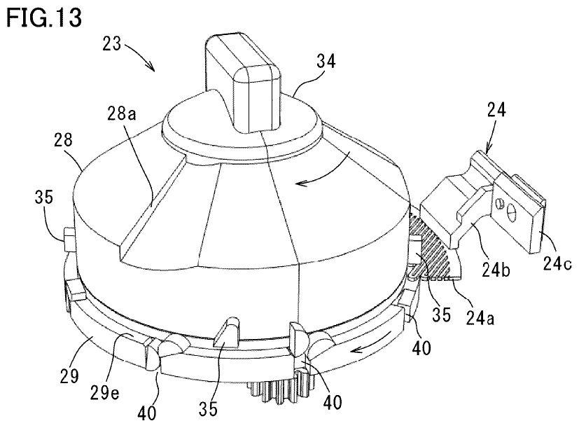

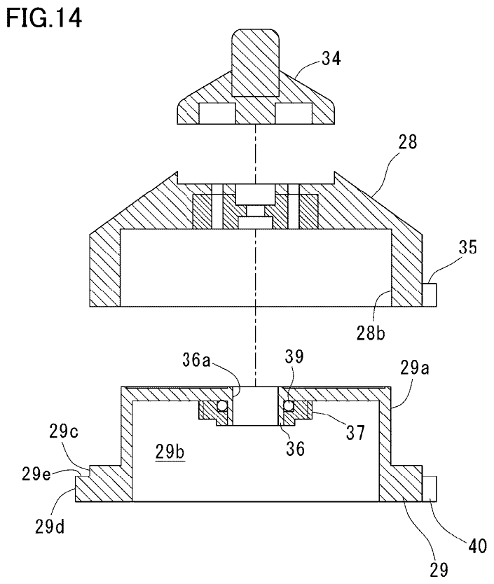

As illustrated in FIG. 13, the first rotor 28 has a conical upper surface, and a plurality of stepped portions 28a for stirring tablets are formed at three locations in the circumferential direction. A cap 34 is attached to a center of an upper surface of the first rotor 28. As illustrated in FIG. 14, a recess portion 28b into which a projecting portion 29a of the second rotor 29 is fitted is formed at a lower surface of the first rotor 28. Protrusions 35 that project outward in the radial direction are formed at lower end edges of an outer peripheral surface of the first rotor 28 at positions at which the circumference is equally spaced by 4.

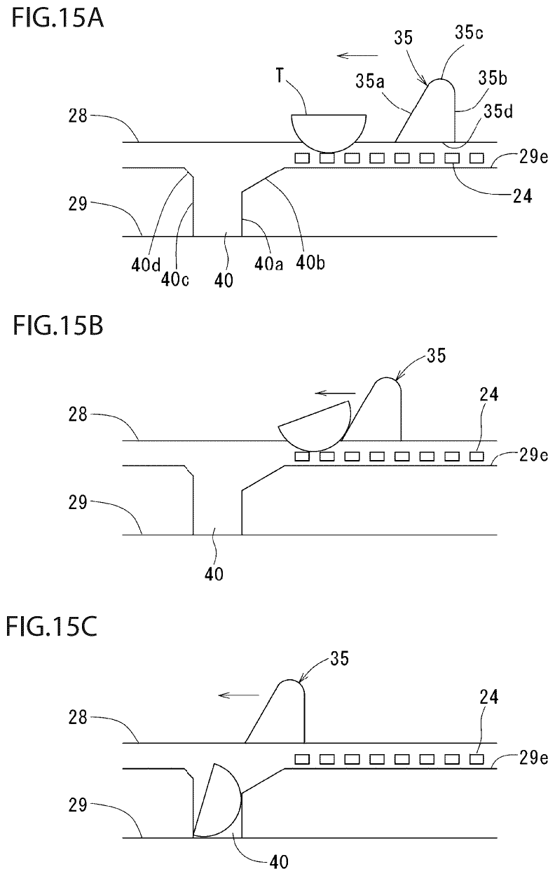

As illustrated in FIG. 15A, the protrusion 35 has a substantially right-angled triangular shape when viewed from a side of the first rotor 28, and has an inclined surface 35a that is provided on a rotation direction downstream side of the first rotor 28 and that is inclined upward toward a rotation direction upstream side of the first rotor 28, a perpendicular surface 35b that is provided on the rotation direction upstream side of the first rotor 28 and that extends in the axial direction of the first rotor 28, a curved surface 35c that connects an upper end of the inclined surface 35a and an upper end of the perpendicular surface 35b, and a bottom surface 35d that is flush with a lower surface of the first rotor 28. As illustrated in FIG. 12, the first rotor 28 engages with and fixed to an upper end of the rotor drive shaft 26, and is integrally rotatable with the rotor drive shaft 26.

As illustrated in FIG. 14, a projecting portion 29a that is fitted to the recess portion 28b of the first rotor 28 is formed at an upper surface of the second rotor 29, and a gear space 29b that houses the second intermediate gear 33 to be described below is formed at a lower surface of the second rotor 29. A shaft portion 36 having a central hole 36a through which the rotor drive shaft 26 penetrates is formed at a center of the second rotor 29. A second rotor gear 37 that drives the second rotor 29 is attached to the periphery of the shaft portion 36 to be integrally rotatable with the second rotor 29. An O-ring 38 that acts as a torque limiter is mounted between the second rotor gear 37 and the shaft portion 36 of the second rotor 29. In the same manner, as illustrated in FIG. 12, an O-ring 39 that also acts as a torque limiter is mounted between the rotor drive shaft 26 and the first rotor gear 30.

As illustrated in FIG. 14, an outer peripheral surface of the second rotor 29 has a small-diameter portion 29c having the same diameter as an outer peripheral surface of the first rotor 28, a large-diameter portion 29d which is located below the small-diameter portion 29c and has a diameter more than the diameter of the small-diameter portion 29c, and a stepped portion 29e that is provided between the small-diameter portion 29c and the large-diameter portion 29d. The tablet guides 40 in a groove shape, which extend in the axial direction, are formed at positions of the large-diameter portion 29d, at which the circumference is equally spaced by 8. As illustrated in FIG. 15A, an inclined surface 40b that is inclined upward toward the rotor rotation direction upstream side is formed between a side surface 40a of the tablet guide 40 on the rotor rotation direction upstream side and the stepped portion 29e. In addition, a chamfer 40d is formed at a corner portion between a side surface 40c on the rotor rotation direction downstream side of the tablet guide 40 and the stepped portion 29e.

The rotation speeds of the first rotor 28 and the second rotor 29 can be adjusted by changing the number of teeth of the gear B 33b of the second intermediate gear 33 (replacing a gear B with a gear B having the different number of teeth). For example, when the first rotor gear 30 and the transfer gear 32 are set to 24 teeth, the gear A 33a of the second intermediate gear 33 is set to 10 teeth, the gear B 33b of the second intermediate gear 33 is set to 11 teeth, and the second rotor gear 37 is set to 23 teeth, and the rotation speed of the transfer gear 32 is set to 100 rpm, a rotation speed of the second rotor gear 37 is 114.8 rpm, and a rotation speed of approximately 1.1 times the rotation speed of the first rotor gear 30 is obtained.

As illustrated in FIG. 13, the partition 24 consists of a brush portion 24a, a support portion 24b, and an attachment portion 24c, and is attached to the tablet housing 22 above the tablet outlet 25a. The brush portion 24a is attached such that a tip of the brush portion 24a is located between the protrusion 35 of the first rotor 28 and the stepped portion 29e of the second rotor 29.

Next, an operation of the tablet dispensing device 21 according to one or more embodiments are described.

A large number of half-tablets housed in the tablet housing 22 are stirred with rotation of the rotor 23, enter the annular pocket portion 27 surrounded by an inner surface of the rotor housing portion 25, an outer peripheral surface of the first rotor 28, and the small-diameter portion 29c and the stepped portion 29e of the second rotor 29, and the tablets in the pocket portion 27 further enter the tablet guide 40 of the second rotor 29. When the tablet guide 40 approaches the tablet outlet 25a by the rotation of the rotor 23, for the tablet of the tablet guide 40, the tablet below the partition 24 is discharged from the tablet outlet 25a and is dispensed through an attachment portion (not illustrated). Each time the tablet guide 40 passes through the tablet outlet 25a, one tablet is discharged, and the number of tablets corresponding to a prescription is packaged and dispensed.

In the related art, when the amount of remaining tablets in the tablet housing 22 is small, a tablet placed on the partition 24 is retained there and is not discharged, and a tablet placed on the stepped portion 29e of the rotor 23 is rotated together with the rotor 23 and is not discharged. In the tablet dispensing device 21 according to one or more embodiments, since the rotation speeds of the first rotor 28 and the second rotor 29 are different and the protrusion 35 is provided on the first rotor 28, the tablet retained on the partition 24 and the stepped portion 29e is reliably guided to the tablet guide 40.

More specifically, the tablet T retained at the partition 24 as illustrated in FIG. 15A is pushed to the rotor rotation direction downstream side by the inclined surface 35a of the protrusion 35 of the first rotor 28 that is moving from the rotor rotation direction upstream side and is separated from the partition 24 as illustrated in FIG. 15B, is moved to the stepped portion 29e of the second rotor 29, and eventually enters the tablet guide 40 and is discharged as illustrated in FIG. 15C.

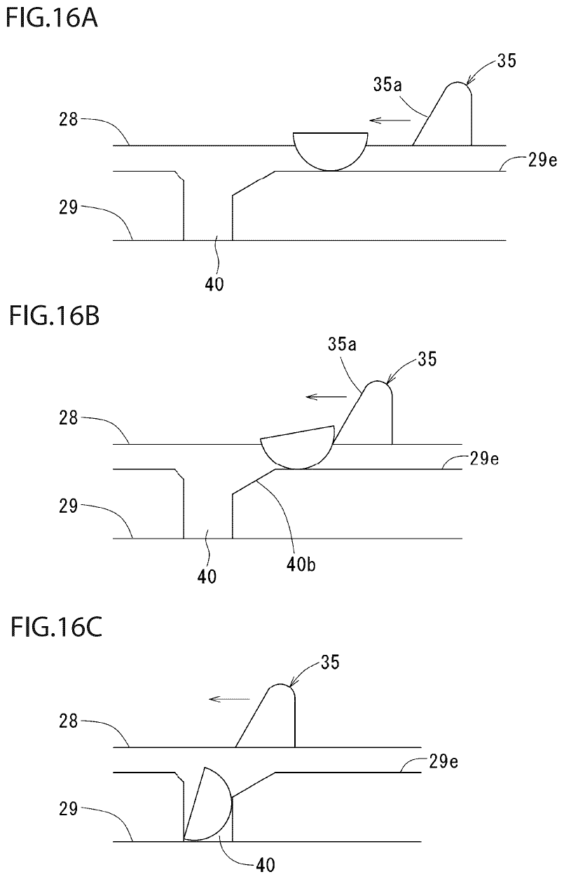

As illustrated in FIGS. 16A, 16B and 16C, since the rotation speed of the first rotor 28 is more than the rotation speed of the second rotor 29, the tablet retained at the stepped portion 29e of the second rotor 29 comes into contact with the inclined surface 35a of the protrusion 35 of the first rotor 28 that rotates relatively with respect to the second rotor 29, is pushed to the rotor rotation direction downstream side, and is eventually introduced into the tablet guide 40 and discharged. Since the inclined surface 35a is inclined upward toward the rotor rotation direction upstream side, the tablet is scooped up by the inclined surface 35a, is inclined along the inclined surface 35a, and smoothly enters the tablet guide 40.

Since the inclined surface 40b that is inclined downward toward the rotor rotation direction downstream side is formed between the side surface 40a of the tablet guide 40 on the rotor rotation direction upstream side and the stepped portion 29e, when the tablet is pushed by the protrusion 35 of the second rotor 29 and approaches the tablet guide 40, the tablet is inclined along the inclined surface 40b and smoothly enters the tablet guide 40.

When the tablet is sandwiched between the first rotor 28 and the tablet guide 40 to cause a block, the O-ring 38 between the second rotor gear 37 and the shaft portion 36 of the second rotor 29 acts as a torque limiter. Therefore, the first rotor 28 slips, and the second rotor 29 is relatively reversed with respect to the first rotor 28. As a result, the force of the protrusion 35 of the second rotor 29 pushing the tablet is reduced, and the bridge of the tablet is eliminated.

In one or more embodiments, the O-ring 38 on the first rotor gear side and the O-ring 39 on the second rotor gear side are provided as the torque limiter, but only one of the O-ring 38 or the O-ring 39 may be provided.

The tablet dispensing device 21 of the second embodiment or embodiments such as is illustrated in FIG. 12 is configured by the following configurations to prevent the tablet from being retained in the partition 24 or the pocket portion and not being discharged in the so-called single-stage rotor.

A tablet dispensing device according to one or more embodiments may include configurations below.

### Configuration 1

A tablet dispensing device comprising:
a tablet housing that houses a tablet and is provided with a tablet outlet through which the tablet is discharged;
a rotor that is disposed inside the tablet housing and is provided with a tablet guide which guides the tablet to the tablet outlet; and
a partition that is located above the tablet guide such that one tablet is discharged to the tablet outlet through the tablet guide,
wherein the rotor includes a first rotor and a second rotor which are coaxial,
a rotation speed of the first rotor and a rotation speed of the second rotor are different from each other, and
the first rotor is provided with a protrusion.

### Configuration 2

The tablet dispensing device according to configuration 1,
wherein the second rotor is formed with a stepped portion that forms a bottom portion of a pocket portion between the tablet housing and the rotor.

### Configuration 3

The tablet dispensing device according to configuration 1 or 2,
wherein a side surface of the protrusion on a rotor rotation direction downstream side is inclined upward toward a rotor rotation direction upstream side.

### Configuration 4

The tablet dispensing device according to any one of configurations 1 to 3,
wherein the first rotor is rotatably provided by a rotor drive shaft, and
the second rotor is rotatably provided by a second rotor gear provided at the second rotor via a transfer gear provided at the rotor drive shaft and an intermediate gear which is provided at the tablet housing and which meshes with the transfer gear.

### Configuration 5

The tablet dispensing device according to any one of configuration 1 to 4,
wherein the tablet guide is formed with an inclined surface which is inclined downward toward a rotor rotation direction downstream side at an upper end of a side surface on a rotor rotation direction upstream side.

### Configuration 6

A tablet dispensing device comprising:
a tablet housing that houses a tablet and discharges the tablet through a tablet outlet;
a rotor that is arranged inside the tablet housing and comprises a tablet guide that guides the tablet to the tablet outlet; and
a partition that partitions the tablet in the tablet guide such that one tablet in the tablet guide is discharged through the tablet guide to the tablet outlet,
wherein the rotor comprises a circumferential groove into which the partition is inserted, the circumferential groove arranged at an outer peripheral surface of the rotor, and
a width of the tablet guide below the circumferential groove is more than a width of the tablet guide above the circumferential groove.

### Configuration 7

A tablet dispensing device comprising:
a tablet housing that houses a tablet and discharges the tablet through a tablet outlet; and
a rotor that is arranged inside the tablet housing and comprises a tablet guide that guides the tablet to the tablet outlet,
wherein the tablet guide comprises a groove having a cross section in an elliptical shape in a direction perpendicular to a shaft of the rotor.

1. A tablet dispensing device comprising:
a tablet housing that houses a tablet and discharges the tablet through a tablet outlet;
a rotor that is arranged inside the tablet housing and comprises a tablet guide that guides the tablet to the tablet outlet; and
a tablet introduction member that guides the tablet held at the tablet housing to the tablet guide.

2. The tablet dispensing device according to claim 1, wherein
the tablet introduction member comprises a rod-shaped body that projects from a side surface of the tablet housing toward the rotor.

3. The tablet dispensing device according to claim 2, wherein
the rod-shaped body has S-shape as viewed from a side surface.

4. The tablet dispensing device according to claim 2, wherein
a tip of the tablet introduction member is positioned away from the tablet housing by a distance less than a diameter of the tablet from an inner surface of the tablet housing in a plan view of the rotor.

5. The tablet dispensing device according to claim 4, wherein
the tip of the tablet introduction member is positioned radially outward of the rotor relative to a center of the tablet guide in the plan view of the rotor.

6. The tablet dispensing device according to claim 2, wherein
the tablet introduction member comprises a plurality of rod-shaped bodies.

7. The tablet dispensing device according to claim 6, wherein
an interval between the plurality of rod-shaped bodies is equal to or more than a diameter of the tablet.

8. The tablet dispensing device according to claim 6, wherein
tips of the plurality of rod-shaped bodies have different heights with respect to the rotor.

9. The tablet dispensing device according to claim 6, wherein
one of the plurality of rod-shaped bodies is inserted into an outer peripheral recess portion arranged in a circumferential direction at a side surface of the rotor.

10. The tablet dispensing device according to claim 1, wherein
the tablet introduction member that moves forward and backward from a tablet housing side.

11. A tablet dispensing device comprising:
a tablet housing that houses a tablet and discharges the tablet through a tablet outlet;
a rotor that is arranged inside the tablet housing and comprises a tablet guide that guides the tablet to the tablet outlet;
a partition that partitions the tablet in the tablet guide such that one tablet in the tablet guide is located at a lower side of the tablet guide; and
a tablet introduction member that changes a posture of the tablet of the tablet guide above the partition.

12. The tablet dispensing device according to claim 11, wherein
a tip of the tablet introduction member is inserted into an outer peripheral recess portion arranged in a circumferential direction at a side surface of the rotor.

13. A tablet dispensing device comprising:
a tablet housing that houses a tablet and discharges the tablet through a tablet outlet;
a rotor that is arranged inside the tablet housing and comprises a tablet guide that guides the tablet to the tablet outlet; and
a partition that partitions the tablet in the tablet guide such that one tablet is discharged through the tablet guide to the tablet outlet,
wherein the rotor comprises a circumferential groove into which the partition is inserted, the circumferential groove arranged at an outer peripheral surface of the rotor, and
the tablet guide comprises a chamfer arranged at an upper end portion of the tablet guide and below the circumferential groove.

14. The tablet dispensing device according to claim 2, wherein
the tablet introduction member that moves forward and backward from a tablet housing side.

15. The tablet dispensing device according to claim 3, wherein
the tablet introduction member that moves forward and backward from a tablet housing side.

16. The tablet dispensing device according to claim 4, wherein
the tablet introduction member that moves forward and backward from a tablet housing side.

17. The tablet dispensing device according to claim 5, wherein
the tablet introduction member that moves forward and backward from a tablet housing side.

18. The tablet dispensing device according to claim 6, wherein
the tablet introduction member that moves forward and backward from a tablet housing side.
